(19) United States
(12) Patent Application Publication
(10) Pub. No.: US 2020/0099917 A1
(43) Pub. Date: Mar. 26, 2020

(54) ROBOTIC LASER GUIDED SCANNING SYSTEMS AND METHODS OF SCANNING

(71) Applicant: Guangdong Kang Yun Technologies Limited, Guangzhou City (CN)

(72) Inventor: Seng Fook Lee, Guangzhou City (CN)

(21) Appl. No.: 16/616,179

(22) PCT Filed: Jun. 15, 2018
(86) PCT No.: PCT/CN2018/091555

§ 371 Date: Nov. 22, 2019

Related U.S. Application Data
(60) Provisional application No. 62/577,737, filed on Oct. 27, 2017.

(51) Int. Cl. H04N 13/221; H04N 5/232; H04N 13/257; G05D 3/20

(52) U.S. Cl. CPC H04N 13/221; G05D 3/20; H04N 13/257; H04N 5/23229

(57) ABSTRACT

A robotic laser guided system for scanning of an object includes a processor configured to define a laser center co-ordinate and a relative width for the object from a first shot of the object; and define an exact position for taking each of the one or more shots after the first shot. The exact position for taking the one or more shots is defined based on the laser center co-ordinate and the relative width. The system includes a feedback module for providing at least one feedback about the exact position for taking the shots; a motion-enabling module comprising at least one wheel for enabling a movement to the exact position for taking the shots one by one based on the feedback; cameras for capturing the shots. The processor may stitch and process the shots to generate at least one 3D model comprising a scanned image of the object.

### CROSS REFERENCE TO RELATED APPLICATIONS

This application is a national stage application under 35 U.S.C. 371 of PCT Application No. PCT/CN2018/091555, filed 15 Jun. 2018, which PCT application claimed the benefit of U.S. Provisional Patent Application No. 62/577,737, filed 27 Oct. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to robotic laser guided scanning systems and methods of scanning of objects and/or environment.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

In the present 3D scanners or systems, there exist multiple limitations. For example, a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space. In addition, the user may have to take shots manually that may increase the user's effort for scanning of the objects and environment.

### SUMMARY

In light of above discussion, there exists need for better techniques for automatic scanning and primarily three-dimensional (3D) scanning of objects without any manual intervention. The present disclosure provides robotic systems and methods for laser guided scanning of objects including at least one of symmetrical and unsymmetrical objects.

An objective of the present disclosure is to provide a laser guided co-ordinate system for advising a robot or a bot to take shots or photos or scan an object/environment.

Another objective of the present disclosure is to provide a robotic laser guided scanning system for 3D scanning of objects and/or environment. The robotic laser guided scanning system is configured to take a first shot and subsequent shots automatically.

Another objective of the present disclosure is to provide a self-moving robotic laser guided scanning system for 3D scanning of objects.

A yet another objective of the present disclosure is to provide a self-moving system for scanning of objects by using laser guided technologies.

Another objective of the present disclosure is to provide a robotic laser guided scanning system for taking shots and scanning of the object.

Another objective of the present disclosure is to provide a self-moving robotic laser guided scanning system configured to scan 3D images of objects without any user intervention.

Another objective of the present disclosure is to provide a robotic laser guided scanning system for scanning of at least one of symmetrical and unsymmetrical objects.

A yet another objective of the present disclosure is to provide a robotic or automatic method for scanning or 3D scanning of at least one of symmetrical and unsymmetrical objects.

Another objective of the present disclosure is to provide a robotic system for generating at least one 3D model comprising a scanned image of the object.

Another objective of the present disclosure is to provide a robotic laser guided scanning system, which is self-moving and may move from one position to other for taking one or more shots of an object/environment. The robotic laser guided scanning system may not require any manual intervention.

The present disclosure provides a robotic laser guided co-ordinate system and method for taking a plurality of shots of the object one by one from specific positions for completing a 360-degree view of the object. The robotic laser guided co-ordinate system may determine specific positions from a first shot and move to the specific positions for taking the shots.

The present disclosure also provides robotic systems and methods for generating 3D model including at least one scanned image of an object comprising a symmetrical and an unsymmetrical object or of an environment without any manual intervention by the user.

The present disclosure also provides robotic systems and methods for generating a 3D model including scanned images of object(s) with a less number of images or shots for completing a 360-degree view of the object.

An embodiment of the present disclosure provides a laser guided scanning system for scanning of an object. The laser guided scanning system includes a processor configured to define a laser center co-ordinate and a relative width for the object from a first shot of the object. The processor is further configured to define an exact position for taking each of the one or more shots after the first shot. The exact position for taking the one or more shots may be defined based on the laser center co-ordinate and the relative width. The laser guided scanning system further includes a feedback module configured to provide at least one feedback about the exact position for taking the one or more shots. The laser guided scanning system furthermore includes a motion-enabling module comprising at least one wheel configured to enable a movement from a position to the exact position for taking the one or more shots one by one based on the at least one feedback. The laser guided scanning system also includes one or more cameras configured to capture the first shot and the one or more shots based on the at least one feedback. The processor may stitch and process the first shot and the one or more shots to generate at least one three dimensional model comprising a scanned image of the object.

According to an aspect of the present disclosure, the laser guided scanning system also includes a laser light configured to switch from a red color to a green color and vice versa. The laser light may indicate the exact position for taking each of the one or more shots separately by turning to the green color.

According to another aspect of the present disclosure, the one or more cameras takes the one or more shots of the object one by one based on the laser center co-ordinate and a relative width of the first shot.

According to a further aspect of the present disclosure, the processor is further configured to define a new position co-ordinate for taking a next shot of the one or more shots based on the laser center co-ordinate and the relative width of the first shot.

Another embodiment of the present disclosure provides a scanning system for a three dimensional (3D) scanning of an object. The scanning system also includes a processor configured to define a laser center for the object from a first shot of the object, wherein the object comprising at least one of a symmetrical object and an unsymmetrical object. The processor is also configured to define an exact position for taking every shot of one or more shots after the first shot, wherein the exact position for taking the one or more shots is defined such that the laser center co-ordinate for the object remains undisturbed. The scanning system also includes a laser light configured to indicate the exact position by using a green color for taking each of the one or more shots separately, wherein a position for taking each of the one or more shots being different. The scanning system further includes a motion-enabling module comprising at least one wheel configured to enable a movement from a position to the exact position for taking the one or more shots one by one based on the at least one feedback. The scanning system also includes a plurality of arms comprising one or more cameras configured to capture the first shot and the one or more shots based on the indication. The arms may enable the cameras to capture shots/images of the object from different angles. The processor my stitch and process the first shot and the one or more shots to generate at least one three-dimensional model comprising a scanned image of the object in real time.

Another embodiment of the present disclosure provides a method for laser guided scanning of an object. The method includes defining a laser center co-ordinate and a relative width for the object from a first shot of the object; defining an exact position for taking for each of one or more shots after the first shot, wherein the exact position for taking the one or more shots is defined based on the laser center co-ordinate and the relative width for the object; providing at least one feedback about the exact position for taking the one or more shots; enabling a movement from a position to the exact position for taking the one or more shots one by one based on the at least one feedback; capturing the one or more shots based on the at least one feedback; and stitching and processing the first shot and the one or more shots to generate at least one three dimensional (3D) model comprising a scanned image of the object.

In some embodiments, the method may further include indicating the exact position by using a green color for taking each of the one or more shots separately, wherein a position for taking each of the one or more shots being different.

According to an aspect of the present disclosure, the processor is configured to process the shots or images in real-time and hence in less time the 3D model is generated.

Another embodiment of the present disclosure provides an automatic method for three-dimensional (3D) scanning of an object. The method includes capturing, defining a laser center co-ordinate for the object from a first shot of the object, wherein the object comprises at least one of a symmetrical object and an unsymmetrical object; defining an exact position for taking every shot of one or more shots after the first shot, wherein the exact position for taking the one or more shots is defined such that the laser center co-ordinate for the object remains undisturbed; indicating the exact position by using a green color for taking each of the one or more shots separately, wherein a position for taking each of the one or more shots being different; moving to the exact position for taking the one or more shots based on the indication; capturing the first shot and the one or more shots one by one based on the indication; and stitching and processing the first shot and the one or more shots to generate at least one three dimensional model comprising a scanned image of the object.

A yet another embodiment of the present disclosure provides a robotic laser guided scanning system for scanning of an object. The system includes a processor configured to: define a laser center co-ordinate and a relative width for the object from a first shot of the object; and define an exact position for taking one or more shots after the first shot, wherein the exact position for taking the one or more shots is defined based on the laser center co-ordinate and the relative width for the object such that the laser center co-ordinate remains undisturbed. The system also includes a laser light configured to indicate the exact position by using a green color for taking each of the one or more shots separately, wherein a position for taking each of the one or more shots being different. The system further includes feedback module configured to provide at least one feedback about the exact position for taking the one or more shots. The method also includes a motion-enabling module comprising at least one wheel configured to enable a movement from a position to the exact position for taking the one or more shots one by one based on at least one of the indication and the at least one feedback. The system also includes a motion-enabling module comprising at least one wheel configured to enable a movement from a position to the exact position for taking the one or more shots one by one based on at least one of the indication and the at least one feedback. The system further includes a plurality of arms comprising one or more cameras configured to capture the first shot and the one or more shots based on at least one of the indication and the at least one feedback. The processor may stitch and process the first shot and the one or more shots to generate at least one three dimensional model comprising a scanned image of the object.

According to an aspect of the present disclosure, a robotic laser guided scanning system takes a first shot (i.e. N1) of an object and based on that, a laser center co-ordinate may be defined for the object.

According to an aspect of the present disclosure, for the second shot, the robotic laser guided scanning system may provide a feedback about an exact position for taking the second shot (i.e. N2) and so on (i.e. N3, N4, and so forth). The robotic laser guided scanning system may self move to the exact position and take the second shot and so on (i.e. the N2, N3, N4, and so on).

According to an aspect of the present disclosure, the robotic laser guided scanning system may need to take few shots for completing a 360-degree view or a 3D view of the object or an environment.

In some embodiments, the feedback module comprises an audio/video module configured to provide feedback as an audio message, a video message and combination of both.

According to another aspect of the present disclosure, the laser center co-ordinate is kept un-disturbed while taking the plurality of shots of the object.

In some embodiments, the laser light points a green light on an exact position for taking a next shot. Similarly, the laser light points a green light for signaling a position from where the next shot of the object for completing a 360-degree view of the object can be taken.

According to another aspect of the present disclosure, the robotic laser guided scanning system on a real-time basis processes the taken shots. In some embodiments, the taken shots and images may be sent to a processor for further processing in a real-time.

According to an aspect of the preset disclosure, the processor may define a laser center co-ordinate for the object from a first shot of the plurality of shots, wherein the processor defines the exact position for taking the subsequent shot without disturbing the laser center co-ordinate for the object based on a feedback.

According to another aspect of the present disclosure, the one or more cameras takes the plurality of shots of the object one by one based on the laser center co-ordinate and a relative width of the first shot.

According to another aspect of the present disclosure, the processor is further configured to define a new position co-ordinate for the user based on the laser center co-ordinate and the relative width of the first shot.

According to another aspect of the present disclosure, the plurality of shots is taken one by one with a time interval between two subsequent shots.

The present disclosure provides a method and a system for scanning of at least one of a symmetrical object and an unsymmetrical object. The unsymmetrical object comprises at least one uneven surface.

According to an aspect of the present disclosure, the processor may be configured to stitch and process the shots post scanning of the object to generate at least one 3D model comprising a scanned image.

According to another aspect of the present disclosure, the robotic laser guided scanning system configured to keep the laser center co-ordinate undisturbed while taking various shots. The laser guided scanning system may take the shots based on the co-ordinate. A relative width of the shot may also help in defining the new co-ordinate for taking next shot. Therefore, by not disturbing the laser center, the laser guided scanning system may capture the overall or complete photo of the object. Hence, there may not be a missing part of the object scanning that in turn, may increase the overall quality of the scanned image or the 3D model.

According to another aspect of the present disclosure, the one or more cameras takes the plurality of shots of the object one by one based on the laser center co-ordinate and a relative width of the first shot.

According to a further aspect of the present disclosure, due to discrete scanning steps, a less amount of shots may be needed for taking the complete 360-degree scanning of an object or an environment.

According to an aspect of the present disclosure, the robotic laser guided scanning system is self-moving and configured to move from one position to other for taking shots based on a feedback about an exact position.

According to a further aspect of the present disclosure, the robotic laser guided scanning system keeps the laser center co-ordinate undisturbed while taking the multiple shots. Further, the shots may be taken based on the laser center co-ordinate. Further, a relative width of the first shot (i.e. N1) may also help in defining a new co-ordinate of the self moving robotic laser guided scanning system for taking multiple shots of the object. Hence, without disturbing the laser center the scanning system can capture the overall or complete photo of the object. Therefore, there won't be any missing part of the object which scanning, which in turn may increase a quality of the scanned image.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment where various embodiments of the present disclosure may function;

FIG. 2 illustrates an exemplary robotic laser guided scanning system according to an embodiment of the present disclosure;

FIGS. 3A-3C are block diagrams illustrating system elements of an exemplary laser guided scanning system, in accordance with various embodiments of the present disclosure; and

FIGS. 4A-4B illustrate a flowchart of a method for automatic three-dimensional (3D) scanning of an object by using the laser guided scanning system of FIGS. 3A-3C, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

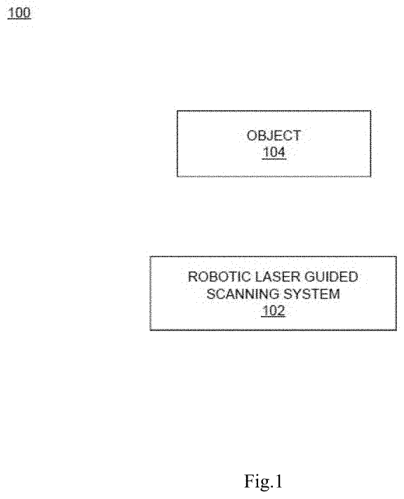

FIG. 1 illustrates an exemplary environment 100 where various embodiments of the present disclosure may function. As shown, the environment 100 primarily includes a robotic laser guided scanning system 102 for scanning or 3D scanning of an object 104. The object 104 may be a symmetrical object and an unsymmetrical object having uneven surface. Though only one object 104 is shown, but a person ordinarily skilled in the art will appreciate that the environment 100 may include more than one object 104.

In some embodiments, the robotic laser guided scanning system 102 (also referred hereinafter as laser guided scanning system or a robotic scanning system) is configured to capture one or more shots including images of the object for generating a 3D model including at least one image of the object 104. In some embodiments, the robotic laser guided scanning system 102 is configured to capture fewer number of images of the object 104 for completing a 360-degree view of the object 104. Further, in some embodiments, the robotic laser guided scanning system 102 may be configured to generate 3D scanned models and images of the object 104. In some embodiments, the robotic laser guided scanning system 102 may be a device or a combination of multiple devices, configured to analyse a real-world object or an environment and may collect/capture data about its shape and appearance, for example, colour, height, length width, and so forth. The robotic laser guided scanning system 102 may use the collected data to construct a digital three-dimensional model.

The robotic laser guided scanning system 102 may indicate an exact position to take one or more shots or images of the object 104. For example, the robotic laser guided scanning system 102 may point a green color light to the exact position for taking a number of shots of the object 104 one by one. For taking each of the shots, the robotic laser guided scanning system 102 points a green light to an exact position from where the next shot of the object 104 should be taken. In some embodiments, the robotic laser guided scanning system 102 includes a laser light configured to switch from a first color to a second color to indicate or signal an exact position for taking a number of shots including at least one image of the object 104. In some embodiments, the first color may be a red color and the second color may be a green color. In some embodiments, the laser guided scanning system comprises a feedback module for providing a feedback about an exact location for taking the next shot(s).

Further, the robotic laser guided scanning system 102 may define a laser center co-ordinate for the object 104 from a first shot of the shots. Further, the robotic laser guided scanning system 102 may define the exact position for taking the subsequent shot without disturbing the laser center co-ordinate for the object. The exact position for taking the subsequent shot is defined without disturbing the laser center co-ordinate for the object 104. Further, the robotic laser guided scanning system 102 is configured to define a new position co-ordinate of the based on the laser center co-ordinate and the relative width of the shot. The robotic laser guided scanning system 102 may be configured to self-move to the exact position to take the one or more shots of the object 104 one by one based on an indication or the feedback. In some embodiments, the robotic laser guided scanning system 102 may take subsequent shots of the object 104 one by one based on the laser center co-ordinate and a relative width of a first shot of the shots. Further, the subsequent one or more shots may be taken one by one after the first shot. For each of the one or more, the robotic laser guided scanning system 102 may point a green laser light on an exact position or may provide feedback about the exact position to take a shot. Furthermore, the robotic laser guided scanning system 102 may capture multiple shots for completing a 360-degree view of the object 104. Furthermore, the robotic laser guided scanning system 102 may stitch and process the multiple shots to generate at least one 3D model including a scanned image of the object 104.

Further, the robotic laser guided scanning system 102 may be configured to process the shots in real-time. This may save the time required for generating the 3D model or 3D scanned image.

The robotic laser guided scanning system 102 may include wheels for self-moving to the exact position. Further, the robotic laser guided scanning system 102 may automatically stop at the exact position for taking the shots. Further, the robotic laser guided scanning system 102 may include one more arms including at least one camera for clicking the images of the object 104. The arms may enable the cameras to capture shots precisely from different angles.

In some embodiments, a user (not shown) may control movement of the robotic laser guided scanning system 102 via a remote controlling device or a mobile device like a phone.

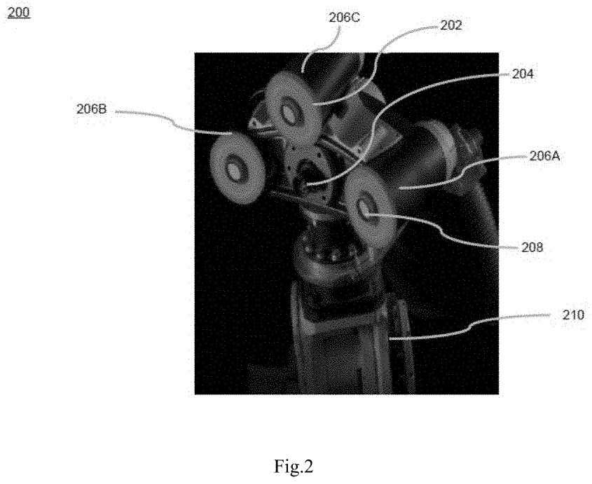

FIG. 2 illustrates a front view 200 of an exemplary robotic laser guided scanning system 202 according to an embodiment of the present disclosure. As shown, the robotic laser guided scanning system 202 includes a laser light 204, multiple arms 206A-206C (collectively referred as 206) including one or more cameras 208, at least one wheel 210 The robotic laser guided scanning system 202 includes the laser light 204 for a pointing a light such as a green light at an exact position for taking one or more shots. As discussed with reference to FIG. 1, the one or more shots may be taken after a first shot of the object 104. The laser light 204 may change from a first color to a second color and vice versa. In some embodiments, the laser light 204 may be configured to switch from a red color to a green color for signaling an exact position for taking each of the one or more shots comprising at least one image of the object. In some embodiments, the laser light 204 is configured to indicate the exact position for taking each of the one or more shots separately by turning to the green color.

The arms 206A-2060 are configured to move. Each of the arms 206 may further include at least one of the cameras 208. The cameras 210 are configured such that they may also move as the arms 206 move. The movement of the arms 206 enables the cameras 208 to take shots of the object 104 from different angles. Further, each of the arms includes at least one of the cameras 208 configured to capture the plurality of shots one by one when the laser light 204 points an exact position via a green light. In some embodiments, the arms 206A-2060 may enable the cameras to capture shots precisely from different angles. Further, the one or more cameras 208 may take the plurality of shots based on a laser center co-ordinate and a relative width of the first shot such that the laser center co-ordinate remains un-disturbed while taking the shots of the object. Further, the one or more cameras 208 may take the one or more shots of the object 104 one by one based on a laser center co-ordinate and a relative width of the first shot. The object 104 may comprise at least one of a symmetrical object and an unsymmetrical object.

The wheel 210 may be configured to enable a movement of the robotic laser guided scanning system 202 from a position to the exact position for taking the one or more shots one by one based on the at least one feedback. The robotic laser guided scanning system 202 can move from one position to other by its own without requiring any user intervention. In some embodiments, a user may control movement of the robotic laser guided scanning system 202 by using a remote controlling device (not shown) or a mobile device. The robotic laser guided scanning system 202 may include the wheel 210 for self-moving to the exact position. Further, the robotic laser guided scanning system 202 may automatically stop at the exact position for taking the shots.

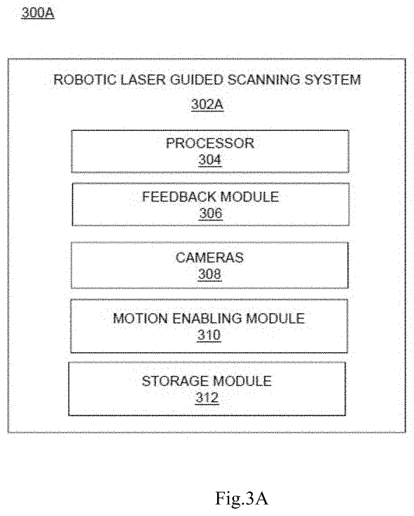

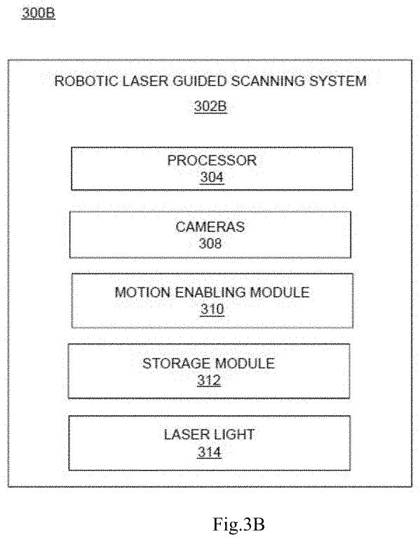

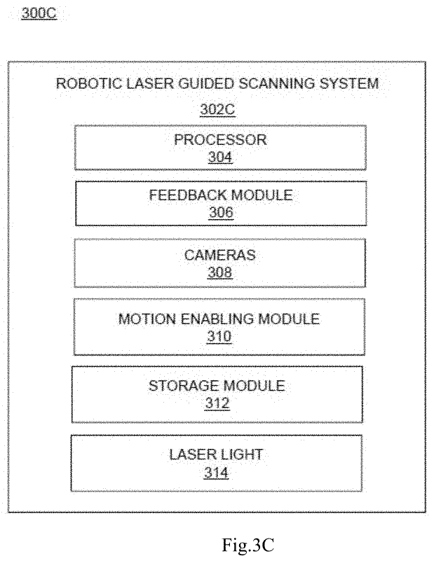

FIGS. 3A, 3B and 3C are block diagrams 300A, 300B, and 300C illustrating system elements of various exemplary robotic laser guided scanning systems 302A, 302B, and 302C, respectively, in accordance with various embodiments of the present disclosure. The block diagram 300A shows a robotic laser guided scanning system 302A primarily including a processor 304, a feedback module 306, one or more cameras 308, a motion-enabling module 310, and a storage module 312. As discussed with reference to FIGS. 1 and 2, the robotic laser guided scanning system 302A may be configured to capture or scan 3D images of the object 104.

The processor 304 is configured to define a laser center co-ordinate and a relative width for the object 104 from a first shot of the object 104. Further, the processor 304 may be configured to define an exact position for taking each of one or more shots after the first shot, wherein the exact position for taking the one or more shots is defined based on the laser center co-ordinate and the relative width. An exact position for taking the subsequent shot may be defined without disturbing the laser center co-ordinate for the object 104. The exact position may comprise one or more position co-ordinates. Further, the processor is configured to process the shots or images in real-time and hence in less time the 3D model is generated.

The feedback module 306 of the system 302A may be configured to provide a plurality of feedback about the exact position for taking the one or more shots of the object 104. The feedback module 306 provides feedback about the location for clicking a next shot of image. In some embodiments, the feedback module 306 comprises an audio/video module configured to provide feedback as an audio message, a video message and combination of both.

The one or more cameras 308 may be configured to capture the first shot and the one or more shots based on at least one of a feedback and a color of the laser light. The one or more cameras 308 may further be configured to take the plurality of shots of the object 104 based on a laser center co-ordinate and a relative width of the first shot. In some embodiments, the laser center co-ordinate may be kept un-disturbed while taking the plurality of shots of the object 104 after a first shot. For each of the shots, the feedback module 306 may provide a feedback about an exact position from where the shot should be captured.

The motion-enabling module 310 may comprise at least one wheel (See wheel 210 in FIG. 2) and may be configured to enable a movement from a position to the exact position for taking the one or more shots one by one based on the at least one feedback. The at least one wheel 210 may move the robotic laser guided scanning system 302A from one place to other based on the feedback received from the feedback module 306. The wheel 210 may auto-stop at the exact position for taking shots of the object 104. In some embodiments, the motion-enabling module 310 also controls the movement of the arms 206 and set the arms at a particular angle so that the cameras 308 can click pictures or scan images of the object 104.

Further, the processor 304 may also be configured to stitch and process the shots to generate at least one 3D model including a scanned image of the object 104. The processor 304 may also be configured to define a new position co-ordinate based on the laser center co-ordinate and the relative width of the shot.

The storage module 312 may be configured to store the images and 3D models. In some embodiments, the storage module 312 may store one or more instructions for the processor 304. In some embodiments, the storage module 312 may be a memory.

Now moving to the block diagram 300B of FIG. 3B, the robotic laser guided scanning system 302B is shown. The robotic laser guided scanning system 302B includes the processor 304, the motion-enabling module 310, the one or more cameras 308, and the storage module 312 similar to the robotic laser guided scanning system 302A. Further, the robotic laser guided scanning system 302B doesn't include the feedback module 306 and may include a laser light 314 in place of the feedback module 306.

The laser light 314 may be configured to switch from a first color to a second color for indicating an exact position for taking a plurality of shots comprising at least one image of the object 104. In some embodiments, the laser light 314 may be configured to switch from a red color to a green color and vice versa, the laser light 314 switches from the red color to the green color for signaling an exact position for taking a shot of one or more shots comprising at least one image of the object 104. In some embodiments, the laser light 314 points a green light on the exact position from where the next shot shout be taken by the cameras 308. In some embodiments, the laser light 314 is configured to switch from a red color to a green color and vice versa. In some embodiments, the laser light 314 may be configured to use colors other than red and green for indicating the exact position.

Turning now to the block diagram 300C of the FIG. 3C, the robotic laser guided scanning system 302C is shown. As shown, the robotic laser guided scanning system 302C includes the feedback module 306 and the laser light 314 both for indicating an exact position for taking the shots. In such embodiments, the cameras 308 are configured to take shots based on the feedback and the indication. The motion-enabling module 310 may move to the position based on at least one of the feedback from the feedback module 306 and an indication from the laser light 314.

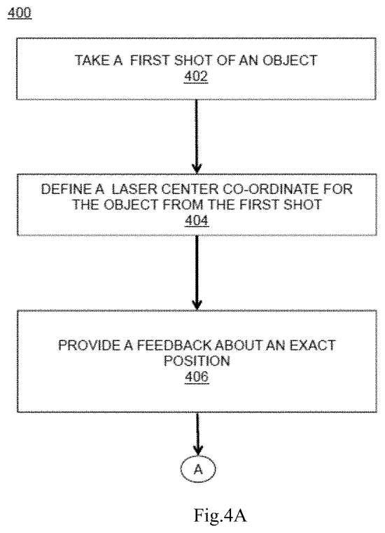

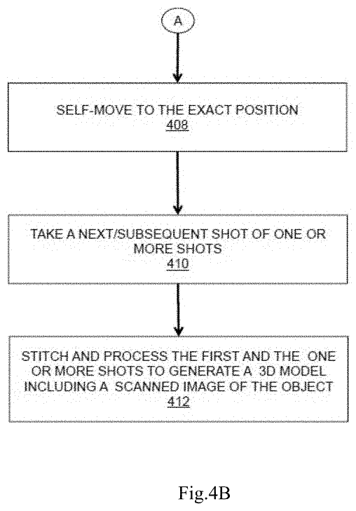

FIGS. 4A-4B illustrates a flowchart of a method 700 for a 3 dimensional (3D) scanning of an object by using a robotic laser guided scanning system such as the robotic laser guided scanning system 302A of FIG. 3A, in accordance with an embodiment of the present disclosure.

At step 402, the robotic laser guided scanning system 302A takes a first shot of the object 104. Then at step 404, the robotic laser guided scanning system 302A defines a laser center co-ordinate for the object from the first shot. In some embodiments, the processor 304 defines the laser center co-ordinate and a relative width base don the first shot.

At step 406, the robotic laser guided scanning system 302A provides a feedback about an exact position for clicking a next shot. At step 408, the robotic laser guided scanning system 302A self-moves to the exact position. In some embodiments, the motion-enabling module 310 controls the movement of the wheel 210 for reaching to the exact position. Then at step 410, the robotic laser guided scanning system 302A takes the next or subsequent shot of the one or more shots of the object 104. Similarly, the one or more shots are taken by following the steps 406-410 for completing a 360-degree view of the object 104

Thereafter at step 412, the first shot and the one or more shots are stitched and processed together to generate at least one 3D model including a scanned image of the object 104. In some embodiments, the processor 304 stitches and processes the shots.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A laser guided scanning system for scanning of an object, comprising:
a processor configured to:
define a laser center co-ordinate and a relative width for the object from a first shot of the object; and
define an exact position for taking each of one or more shots after the first shot, wherein the exact position for taking the one or more shots is defined based on the laser center co-ordinate and the relative width;
a feedback module configured to provide at least one feedback about the exact position for taking the one or more shots;
a motion-enabling module comprising at least one wheel configured to enable a movement from a position to the exact position for taking the one or more shots one by one based on the at least one feedback; and
one or more cameras configured to capture the first shot and the one or more shots one by one based on the indication; and
wherein the processor stitches and processes the first shot and the one or more shots to generate at least one three dimensional model comprising a scanned image of the object.

2. The laser guided scanning system of claim 1 further comprising a laser light configured to switch from a red color to a green color and vice versa, wherein the laser light is further configured to indicate the exact position for taking each of the one or more shots separately by turning to the green color.

3. The laser guided scanning system of claim 1, wherein the one or more cameras takes the one or more shots of the object one by one based on the laser center co-ordinate and a relative width of the first shot.

4. The laser guided scanning system of claim 2, wherein the processor is further configured to define a new position co-ordinate for taking a next shot of the one or more shots based on the laser center co-ordinate and the relative width of the first shot.

5. The laser guided scanning system of claim 1, wherein the object comprises at least one of a symmetrical object and an unsymmetrical object.

6. A scanning system for a three dimensional (3D) scanning of an object, comprising:
a processor configured to:
define a laser center co-ordinate for the object from a first shot of the object, wherein the object comprising at least one of a symmetrical object and an unsymmetrical object; and
define an exact position for taking every shot of one or more shots after the first shot, wherein the exact position for taking the one or more shots is defined such that the laser center co-ordinate for the object remains undisturbed; and
a laser light configured to indicate the exact position by using a green color for taking each of the one or more shots separately, wherein a position for taking each of the one or more shots being different;
a motion-enabling module comprising at least one wheel configured to enable a movement to the exact position for taking the one or more shots based on at least one of an indication and a feedback; and
a plurality of arm comprising one or more cameras configured to capture the first shot and the one or more shots based on the indication, wherein the plurality of arm enable the one or more cameras to take the shots of the object from different angles; and
wherein the processor stitches and processes the first shot and the one or more shots to generate at least one three dimensional model comprising a scanned image of the object in real-time.

7. The scanning system of claim 6 further comprising a feedback module configured to provide a plurality of feedback about the exact position for taking each of the one or more shots separately, wherein a position for taking each of the one or more shots is different.

8. The scanning system of claim 6, wherein for each of the one or more shots, the processor is further configured to define a new position co-ordinate for the user based on the laser center co-ordinate and the relative width of the first shot.

9. A method for laser guided scanning of an object, comprising:
defining a laser center co-ordinate and a relative width for the object from a first shot of the object;
defining an exact position for taking for each of one or more shots after the first shot, wherein the exact position for taking the one or more shots is defined based on the laser center co-ordinate and the relative width for the object;
providing at least one feedback about the exact position for taking the one or more shots;
enabling a movement from a position to the exact position for taking the one or more shots one by one based on the at least one feedback;
capturing the one or more shots based on the at least one feedback; and
stitching and processing the first shot and the one or more shots to generate at least one three dimensional (3D) model comprising a scanned image of the object.

10. The method of claim 9 further comprising indicating the exact position by using a green color for taking each of the one or more shots separately, wherein a position for taking each of the one or more shots being different.

11. The method of claim 9, wherein the one or more shots of the object are captured one by one based on the laser center co-ordinate and a relative width of the first shot.

12. The method of claim 9 further comprising defining a new position co-ordinate for taking a next shot of the one or more shots based on the laser center co-ordinate and the relative width of the first shot.

13. The method of claim 9, wherein the object comprises at least one of a symmetrical object and an unsymmetrical object.

14.-17. (canceled)
